(19) United States
(12) Patent Application Publication
(10) Pub. No.: US 2016/0311386 A1
(43) Pub. Date: Oct. 27, 2016

(54) ELEMENT OF AN ENGINE COMPARTMENT OF A MOTOR VEHICLE AND METHOD OF PROTECTING THE ELEMENT AGAINST CHEMICAL ATTACKS FROM A METAL HALIDE

(71) Applicant: HUTCHINSON, Paris (FR)

(72) Inventors: Baptiste Voillequin, Bois-Le-roi (FR); Katerina Kirkorian, Fontainebleau (FR); Matthieu Vatan, Puiseaux (FR); Nicolas Garois, Amilly (FR)

(73) Assignee: HUTCHINSON, Paris (FR)

(21) Appl. No.: 15/105,322

(22) PCT Filed: Dec. 19, 2013
(86) PCT No.: PCT/FR2013/053193

§ 371 Date: Jun. 16, 2016

(51) Int. Cl. B60R 16/08; B32B 15/088; B32B 1/08; B62D 29/04; F16L 11/04

(52) U.S. Cl. CPC B60R 16/08; B62D 29/043; F16L 11/045; B32B 1/08; B32B 15/088; B32B 2597/00

(57) ABSTRACT

An element of an engine compartment of a motor vehicle and a method of protecting this element against chemical attacks by a metal halide is described. The element has at least one external layer of a wall having a thermoplastic composition based on polyamide. The thermoplastic composition is based on at least one polyamide that has at least one polymer chain with two ends comprising functional end groups. The at least one polyamide is selected from the group consisting of PA 6, PA 6.6 and mixtures thereof and the composition comprises the product of the reaction, preferably by reactive extrusion, of at least one bifunctional or multifunctional chain extender compound with at least one part of the functional groups. The element is capable of resisting prolonged contact with a metal halide of an alkaline, alkaline-earth or transition metal without breaking.

The present invention relates to an element of an engine compartment of a motor vehicle whereof at least one external layer of the wall comprises a thermoplastic composition based on at least one polyamide, and a method of protecting this element against chemical attacks from a metal halide. The invention applies especially to any element of a mechanical support structure or a fluid transfer circuit mounted under the engine hood of the motor vehicle which can be made of material based on one or more polyamides, such as a pipe or hose, an engine support, pulleys or transmission rollers, by way of example and non-limiting.

As is known, pipes or external coatings of pipes housed in the engine compartments of motor vehicles, which are made of polyamides are most often based on polyamide PA 11, PA 12 or PA 6.12, in particular because these specific polyamides exhibit satisfactory resistance to metal halides such as zinc chloride, which can be generated in the presence of products such as road salts for example snow-clearance salts which can infiltrate in under the engine hood. In fact, these salts are chemically highly aggressive for other polyamides such as PA 6 and PA 6.6, which are likely to be degraded especially by being the origin of stress-cracking on contact with these halides.

But a major disadvantage of the use of PA 11, PA 12 and PA 6.12 in these pipes is their high cost by comparison with that of PA 6 and PA 6.6 (so-called “convenience polyamides”).

Document US-B2-7 579 058 aims to resolve this dual problem of limited resistance of PA 6 or PA 6.6 pipes to zinc chloride and of the relatively high cost of other conventionally used PA 11, PA 12 and PA 6.12 polyamides, by choosing to use for an air-brake circuit a multi-layer pipe whereof the external layer is based on polyamide coming from monomer units containing an average of at least eight carbon atoms (i.e. excluding PA 6 and PA 6.6), such as for example PA 6.12, PA 11 and PA 12.

The solution proposed in this document has the disadvantage of requiring a relatively complex method to carry out for making this multi-layer pipe, in addition to requiring the use of these costly polyamides, especially PA 6.12, PA 11 and PA 12, which further raises the cost of this pipe.

An aim of the present invention is to propose an element of an engine compartment of a motor vehicle (i.e. located under the engine hood), the element having an external mono-layer or multi-layer wall, which remedies the above disadvantages, and this aim is achieved in that the Applicant has recently unexpectedly discovered that if at least one bifunctional or multifunctional chain extender compound is caused to react by reactive extrusion with at least some of the functional terminal groups of a PA 6 and/or PA 6.6 which this wall or an external layer of the latter comprises, then the element can be protected against chemical attacks from metal halides coming into contact with this element, in particular zinc chloride, zinc iodide, copper chloride or calcium chloride, effectively and at less cost.

More precisely, the element has this wall or at least one external layer of the latter which comprises a thermoplastic composition based on at least one polyamide comprising at least one polymer chain comprising functional groups at both its ends and, according to the invention, said at least one polyamide is selected from the group consisting of PA 6, PA 6.6 and mixtures thereof, the composition comprising the product of a reaction of at least one bifunctional or multifunctional chain extender compound with at least some of these functional groups, the element being capable of resisting prolonged contact with a metal halide of an alkaline, alkaline-earth or transition metal without breaking.

It has to be noted that this use of one or more “convenience” polyamide(s) (i.e. PA 6 and/or PA 6.6) for making an element of the invention reduces its production cost in comparison with a similar element made from a polyamide such as PA 11, PA 12 and PA 6.12.

It has further to be noted that this reaction between the chain extender compound(s) and the functional end groups of PA 6 and/or PA 6.6 effectively protects these end groups which constitute a weakness of PA 6 and PA 6.6 relative to metal halides, and reduce the number of these groups and restructure the polymer chains of PA 6 and PA 6.6.

Advantageously, said wall or said at least one external layer of said wall can consist (i.e. exclusively) of said thermoplastic composition free of polyamide other than PA 6 and PA 6.6 such as PA 11, PA 12 and PA 6.12.

Even more advantageously, the element can be an extruded mono-layer or multi-layer pipe usable in a circuit of said engine compartment selected from air-conditioning, power steering, fuel, water and air circuits.

According to another characteristic of the invention, the element can be capable of resisting said contact for a period of two days and at a temperature of 70° C. in a bath consisting of said metal halide in aqueous solution concentrated at 50% by mass of this halide, without showing breakage following residual tensile strength tests with relative tensile stresses of 5%, 10% or even 50% or even 100% applied to the element.

Advantageously, the element can be capable of resisting said contact without showing breakage, cracking or alteration of its mechanical properties, as per tests on test pieces of type H2 (dumbbells) made of material plates which are described in paragraphs 6.2.1. and 7. of the manufacturer standard RENAULT D47 1924/-C created in 1995 and modified in 2012.

More generally, it has to be noted that modification according to the invention of PA 6 and/or PA 6.6 by said at least one bifunctional or multifunctional chain extender improves resistance to chemical attacks, ageing and the mechanical properties of the element consisting in full or part of said composition, such as hydrolytic stability, stress-cracking and resistance to shocks, especially.

According to another characteristic of the invention, said at least one bifunctional or multifunctional compound can comprise one or more oligomer(s) of average molecular mass in number Mn comprised between 3000 and 10000 g/mol, which react(s) with carboxylic and/or amine and/or hydroxyl functions included in said functional groups and which is or are present in said composition according to a total quantity of this/these compound(s) equal to or greater than 0.3 part by weight per one hundred parts of polyamide(s) PA 6 and/or PA 6.6.

According to a first embodiment of the invention, said at least one compound comprises a bifunctional compound selected from the group consisting of bisoxazolines, bisepoxides (e.g. 2,6-dibenzalcyclohexanone bis-epoxide), polycarbodiimides, bisphenol diglycidyl ethers, caprolactames blocked diisocyanate, fluorenylmethanols, biscaprolactames, bisacyl lactames (e.g. TBCL and TBLL), dianhydrides (e.g. 3,3′,4,4′-benzophenone tetracarboxylic dianhydride or BTDA, and pyromellitic dianhydride or PMDA), fluorenylmethylchloroformates, terephtaloylbislaurolactames and mixtures thereof, this or each bifunctional compound being present in said composition according to a quantity which can be inclusively comprised between 0.3 and 3 part by weight per one hundred parts of polyamide(s) PA 6 and/or PA 6.6.

Preferably in relation to this first mode, said at least one bifunctional compound preferably comprises in combination a bisoxazoline, preferably 2,2′-(1,3-phenylene)bis(2-oxazoline) or 2,2′-(1,4-phenylene)bis(2-oxazoline), and a biscaprolactame, preferably 1,1′-isophthaloyl biscaprolactame.

It has to be noted that the Applicant has demonstrated an advantageous and unexpected synergy effect of the combination of these two bifunctional chain extender compounds, since this combination confers more improved resistance to attacks by the above metal halides and mechanical properties overall better than with the only isoxazoline and with the only biscaprolactame.

According to a second embodiment of the invention which can be combined with said first mode, said at least one compound comprises a multifunctional compound selected from the group consisting of the modified styrene-acrylate copolymers, modified polymers of styrene and acrylic acid, styrene-maleic anhydride copolymers and mixtures thereof, this or each multifunctional compound able to be present in said composition according to a quantity inclusively comprised between 0.3 and 3 part by weight per one hundred parts of polyamide(s) PA 6 and/or PA 6.6.

According to an example of the invention, said at least one polyamide comprises a mixture of PA 6 and PA 6.6, the composition further comprising in this case at least one compatibilizer belonging to the family of copolymers of at least one olefin and a methacrylate.

Preferably, said halide is a chloride or an iodide, said metal being selected from the group consisting of zinc, copper and calcium. Even more preferably, said metal halide is selected from the group consisting of zinc chloride, zinc iodide, copper chloride, calcium chloride and mixtures thereof.

According to another aspect of the invention, said external wall can be coated at least partially by said metal halide, for example zinc chloride produced in the presence of a road salt (e.g. snow-clearance salt) having entered said engine compartment.

A method of protecting, according to the invention, an element of an engine compartment of a motor vehicle, in particular a pipe, against chemical attacks from a metal halide, e.g. zinc chloride, zinc iodide, copper chloride or calcium chloride, coming into contact with the element, comprises a reaction by reactive extrusion of at least one bifunctional or multifunctional chain extender compound with at least one part of said functional end groups of a PA 6 and/or PA 6.6 which said at least one polyamide comprises.

According to another characteristic of the invention, this method can comprise the use, for said at least one compound, of the above oligomer(s) of molecular mass Mn comprised between 3000 and 10000 g/mol, which react(s) with carboxylic and/or amine and/or hydroxyl functions included in these functional groups and which is or are present in the composition according to a total quantity equal to or greater than 0.3 part by weight per one hundred parts of polyamide(s) PA 6 and/or PA 6.6.

Advantageously, this method can comprise the use of several so-called bifunctional compounds including the above combination of a bisoxazoline and a biscaprolactame producing a synergistic effect.

It has to be noted that the reaction of this bisoxazoline with the two carboxylic acid end groups of PA 6 or PA 6.6 can be illustrated by the following reactional diagram:

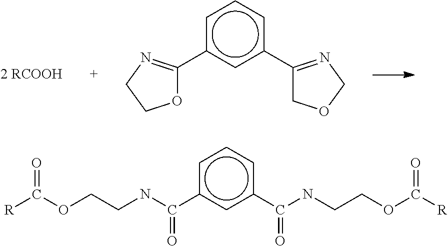

The above characteristics of the present invention, as well as others, will be better understood from the following description of several embodiments of the invention, given by way of illustration and non-limiting in relation to the appended drawings, in which:

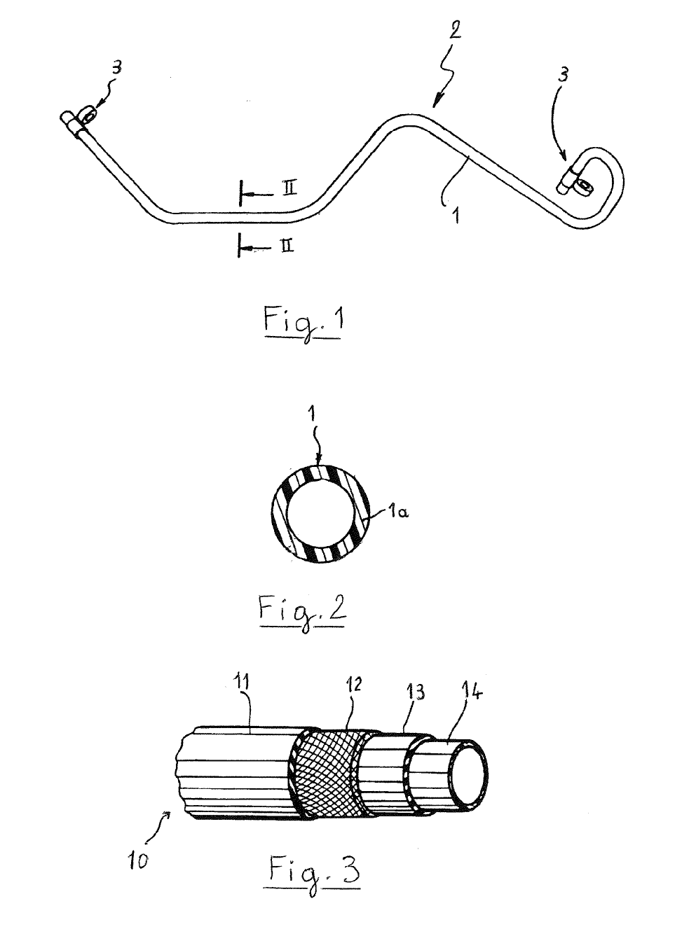

FIG. 1 is a schematic view in perspective of an air-conditioning circuit hose comprising an element forming a pipe according to the invention,

FIG. 2 is a view in transversal section along the plane II-II of FIG. 1 of this pipe in the event where it is mono-layer, and

FIG. 3 is a schematic and exploded view in perspective of a multi-layer pipe usable according to a variant of the invention.

In the following examples thermoplastic “proof” compositions were prepared according to the invention by reactive extrusion in a “co-rotating twin-screw” extruder implemented at a temperature of around 265° C.

The resulting compositions are in particular usable in an extruded pipe 1 of a hose inside an air-conditioning circuit of a motor vehicle, such as the hose 2 illustrated in FIG. 1.

As is known, such a circuit is closed and comprises several elements which are distributed inside the engine compartment of the vehicle, especially a compressor, a condenser, a dehydrating tank, a trigger system and an evaporator and in which coolant circulates. All these elements are connected by hoses 2 comprising tubular elements or rigid and/or flexible pipes 1 which have a fastening element and sealing connection means 3 towards each of their ends.

Each extruded pipe 1 is formed as per a three-dimensional configuration as a function of the path it must follow. The length of each pipe 1 is variable, given that it can have an inner diameter of the order of 4 to 12 mm and a thickness of the order of 0.8 to 3 mm, by way of non-limiting example.

As seen in FIG. 2, the pipe 1 preferably has a single layer 1a consisting of a composition according to the invention which comprises the product of a reaction of hot reactive extrusion of a PA 6 and/or PA 6.6 with at least one chain extender compound according to the invention.

In the variant of FIG. 3, the pipe 10 comprises an external layer 11 consisting of a composition according to the invention and, radially towards the interior of the layer 11, a reinforcing layer 12 (e.g. textile or metal), an optional intermediate layer 13 and an internal layer 1 both polymeric and for example based on one or more polyamide(s) identical or different to that or those of the external layer 11.

### EXAMPLES

The abbreviations used in table 1 below designate and identify the chain extender compounds tested in the examples, as well as other compounds also usable in the present invention.

TABLE 1

| Abbreviations of | Scientific names or characteristics of | No. of CAS/ |
|---|---|---|
| test compounds | compounds (mass rates W/W) | supplier |
| 1,3 PBO | 2,2′-(1,3-phenylene)bis(2-oxazoline) | 34052-90-9 |
| 1,4 PBO | 1,4-bis(4,5-dihydro-2-oxazolyl)benzene | 7426-75-7 |
| 2 BO | 2,2′-bis(2-oxazoline) | 36697-72-0 |
| PBOX | 1,4 bisphenylene bisoxazine | |
| IBC | 1,1′-isophthaloylbiscaprolactame | 7381-13-7 |
| TBC | 1,1′-(p-phenylenedicarbonyl)bis | 2669-15-0 |
| | [hexahydro-2H-azepin-2-one] | |
| CBC | 1,1′-Carbonyl bis caprolactame | 19494-73-6 |
| ADR3400 Joncryl | Styrene-maleic anhydride copolymer | BASF |
| ADR 4300S | Modified styrene-acrylate copolymer: - | BASF |
| Joncryl | styrene: 0.1-0.5%- | |
| | methyl methacrylate; methyl 2- | |
| | methylprop-2-enoate; methyl 2- | |
| | methylpropenoate: 0.1-0.5% | |
| ADR 4368CS | Modified styrene-acrylic polymer: - | BASF |
| Joncryl | styrene: 0.1-0.5%- | |
| | glycidyl methacrylate; 2,3-epoxypropyl | |
| | methacrylate: 0.1-1% | |
| DGEBA | Diglycidyl ether of bisphenol A | |

A first series of tests is conducted by preparing compositions whereof the polymer matrix consisted exclusively of PA 6 and which comprised first, a “control” composition T1 free of any chain extender compound and second, compositions according to the invention I1 to I9 each comprising one, two or three chain extender compound(s) having reacted with this PA 6, as seen in the table 2 below. The quantities indicated in tables 2 and 3 of tested formulations are parts by weight per 100 parts of PA 6 and/or PA 6.6.

TABLE 2

| Ingredients | T1 | I1 | I2 | I3 | I4 | I5 | I6 | I7 | I8 | I9 |
|---|---|---|---|---|---|---|---|---|---|---|
| PA 6 Akulon | 100 | 100 | 100 | 100 | 100 | 100 | 100 | 100 | 100 | |
| F136-DH | | | | | | | | | | |
| 1,3 PBO | | | 1.0 | 1.0 | 1.0 | | | 1.0 | 1.0 | |
| ADR 3400 | | | | 1.0 | | | 1.0 | | | |
| ADR 4300S | | | | | | 1.0 | | | | |
| IBC | | 1.0 | | 0.8 | 0.8 | | | 0.8 | 1.0 | |
| Oligomer PA | | | | | | | | 0.3 | 0.3 | |
| ADR 4368CS | | | | | | | | | | 0.8 |

A second series of tests is conducted by preparing other compositions whereof the polymer matrix consisted of a compatibilized mixture of PA 6 and PA 6.6 in identical mass proportions and which comprised first, a “control” composition T2 free of any chain extender compound and second, compositions according to the invention I10 to I19 each comprising one, two, three or four chain extender compound(s) having reacted with this PA 6+PA 6.6 matrix, as seen in table 3 below (given that the compatibilizer Lotader AX8840 used for these compositions T2 and I10-I19 is a statistical copolymer of ethylene and glycidylmethacrylate).

TABLE 3

| Ingredients | T2 | I10 | I11 | I12 | I13 | I14 | I15 | I16 | I17 | I18 | I19 |
|---|---|---|---|---|---|---|---|---|---|---|---|
| PA 6 Akulon | 50 | 50 | 50 | 50 | 50 | 50 | 50 | 50 | 50 | 50 | 50 |
| F136-DH | | | | | | | | | | | |
| PA 6.6 Akulon | 50 | 50 | 50 | 50 | 50 | 50 | 50 | 50 | 50 | 50 | 50 |
| S223-D black | | | | | | | | | | | |
| Lotader | 10 | 10 | 10 | 10 | 10 | 10 | 10 | 10 | 10 | 10 | 10 |
| AX8840 | | | | | | | | | | | |
| ADR 3400 | | | | | | | | | 0.3 | | |
| ADR 4368CS | | | | | | | 0.3 | | | | |
| 1,3 PBO | | | | | 0.5 | | 0.3 | | 0.55 | | |
| 1,4 PBO | | | | 0.55 | | | | 0.55 | | | 0.8 |
| IBC | | 0.55 | | | 0.55 | 0.55 | 0.55 | 0.55 | 0.55 | 0.8 | |
| DGEBA | | | 0.55 | | | 0.55 | 0.3 | | | | |

Residual tensile strength tests (DRt at 5% and 10% stress) were conducted on test pieces H2 (of dumbbell type) respectively consisting of these “control” compositions T1, T2 and I1 to I19 according to the invention, to evaluate the resistance of elements consisting of these compositions against chemical attack from metal halides, especially including zinc chloride.

For this, these test pieces H2 were previously subjected to conditioning over eight days to make the PA 6 and/or the PA 6.6 of these tested compositions sufficiently humid, then these test pieces H2 were subjected to tests according to paragraphs 6.2.1. and 7. of the manufacturer standard RENAULT D47 1924/-C created in 1995 and modified in 2012. For this purpose, by means of a usual DRt assembly, these test pieces were dipped in a bath of zinc chloride (ZnCl₂) in aqueous solution concentrated at 50% in mass for a period of 48 hours (with three test pieces per bath) and in an oven at 70° C.

These DRt tests showed that the test pieces H2 consisting of compositions I1 to I19 according to the invention showed no breakage, or cracking after this ageing on contact with zinc chloride, as compared to the pieces consisting of “control” compositions T1 and T2 which were sectioned on completion of the applied relative stresses of 5% and 10%.

In particular, the compositions I3, I4, I7, I8, I13, I15 and I17 according to the invention which are characterized in that they comprise the combination of a bisoxazoline (1,3 PBO) and a biscaprolactame (IBC) have surprisingly given the best results in terms of DRt tests following this contact with zinc chloride, attesting to a remarkable synergistic effect.

It was also shown that the mechanical properties of compositions I1 to I9 and I10 to I19 according to the invention were retained overall, or even improved in comparison with those of the “control” compositions T1 and T2, respectively. In particular, the following values were obtained (see table 4) for breaking stress, breaking elongation, yield stress and modulus E, for a novel composition 120 according to the invention (based on PA 6+PA 6.6 mixture and 0.5 part by weight of 1,3 PBO per 100 parts of PA 6+PA 6.6) relative to the composition T2.

TABLE 4

| Mechanical properties | T2 | I20 |
|---|---|---|
| Breaking stress (MPa) | 54 | 56 |
| Breaking elongation (%) | 238 | 237 |
| Yield stress (MPa) | 61 | 63 |
| Modulus E (MPa) | 2171 | 2206 |

1. An element of an engine compartment of a motor vehicle, the element having an external mono-layer or multi-layer wall, said wall or at least one external layer of said wall comprising a thermoplastic composition based on at least one polyamide comprising at least one polymer chain comprising functional end groups, wherein said at least one polyamide is selected from the group consisting of PA 6, PA 6.6 and mixtures thereof and said composition comprises the product of a reaction of at least one bifunctional or multifunctional chain extender compound with at least some of said functional groups, the element being capable of resisting prolonged contact with a metal halide of an alkaline, alkaline-earth or transition metal without breaking.

2. The element according to claim 1, wherein said wall or said at least one external layer of said wall consists of said thermoplastic composition free of polyamide other than PA 6 and PA 6.6 such as PA 11, PA 12 and PA 6.12.

3. The element according to claim 1, wherein the element is an extruded mono-layer or multi-layer pipe usable in a circuit of said engine compartment selected from air-conditioning, power steering, fuel, water and air circuits.

4. The element according to claim 1, wherein the element is capable of resisting said contact for a period of two days and at a temperature of 70° C. in a bath consisting of said metal halide in aqueous solution concentrated at 50% by mass of this halide, without showing breakage following residual tensile strength tests with relative tensile stresses of 5% and 10% applied to the element.

5. The element according to claim 1, wherein the element is capable of resisting said contact without showing breakage, cracking or alteration of its mechanical properties, as per tests on test pieces of type H2 made of material plates which are described in paragraphs 6.2.1. and 7. of the manufacturer standard RENAULT D47 1924/-C created in 1995 and modified in 2012.

6. The element according to claim 1, wherein at least one bifunctional or multifunctional compound comprises one or more oligomer(s) of average molecular mass in number Mn comprised between 3000 and 10000 g/mol, which react(s) with carboxylic and/or amine and/or hydroxyl functions included in said functional groups and which is or are present in said composition according to a total quantity of this/these compound(s) equal to or greater than 0.3 part by weight per one hundred parts of polyamide(s) PA 6 and/or PA 6.6.

7. The element according to claim 6, wherein said at least one compound comprises a bifunctional compound selected from the group consisting of bisoxazolines, bisepoxides, polycarbodiimides, bisphenol diglycidyl ethers, caprolactames blocked diisocyanate, fluorenylmethanols, biscaprolactames, bisacyl lactames, dianhydrides, fluorenylmethylchloroformates, terephtaloylbislaurolactames and mixtures thereof, this or each bifunctional compound being present in said composition according to a quantity inclusively comprised between 0.3 and 3 part by weight per one hundred parts of polyamide(s) PA 6 and/or PA 6.6.

8. The element according to claim 7, wherein said at least one bifunctional compound comprises in combination:
a bisoxazoline, preferably 2,2′-(1,3-phenylene)bis(2-oxazoline) or 2,2′-(1,4-phenylene)bis(2-oxazoline), and
a biscaprolactame, preferably 1,1′-isophthaloyl biscaprolactame.

9. The element according to claim 6, wherein said at least one compound comprises a multifunctional compound selected from the group consisting of the modified styrene-acrylate copolymers, modified polymers of styrene and acrylic acid, styrene-maleic anhydride copolymers and mixtures thereof, this or each multifunctional compound being present in said composition according to a quantity inclusively comprised between 0.3 and 3 part by weight per one hundred parts of polyamide(s) PA 6 and/or PA 6.6.

10. The element according to claim 1, wherein said at least one polyamide comprises a mixture of PA 6 and PA 6.6, said composition further comprising at least one compatibilizer belonging to the family of copolymers of at least one olefin and a methacrylate.

11. The element according to claim 1, wherein said halide is a chloride or an iodide, said metal being selected from the group consisting of zinc, copper and calcium, and preferably said metal halide is selected from the group consisting of zinc chloride, zinc iodide, copper chloride, calcium chloride and mixtures thereof.

12. The element according to claim 1, wherein said external wall is coated at least partially by said metal halide, for example zinc chloride produced in the presence of a snow-clearance salt having entered said engine compartment.

13. A method of protecting an element of an engine compartment of a motor vehicle, in particular a pipe, against chemical attacks from a metal halide, in particular zinc chloride, zinc iodide, copper chloride or calcium chloride, coming into contact with the element, which has an external mono-layer or multi-layer wall, said wall or at least one external layer of said wall comprising a thermoplastic composition based on at least one polyamide comprising at least one polymer chain comprising functional end groups, wherein it comprises a reaction by reactive extrusion of at least one bifunctional or multifunctional chain extender compound with at least one part of said functional groups of PA 6 and/or PA 6.6 which said at least one polyamide comprises.

14. The method of protecting an element according to claim 13, wherein it comprises the use, for said at least one bifunctional or multifunctional compound, of one or more oligomer(s) of average molecular mass in number Mn comprised between 3000 and 10000 g/mol, which react(s) with carboxylic and/or amine and/or hydroxyl functions included in said functional groups and which is or are present in said composition according to a total quantity of this/these compound(s) equal to or greater than 0.3 part by weight per one hundred parts of polyamide(s) PA 6 and/or PA 6.6.

15. The method of protecting an element according to claim 13, wherein it comprises use in combination, for said at least one bifunctional or multifunctional compound:
according to a quantity inclusively comprised between 0.3 and 3 part by weight per one hundred parts of polyamide(s) PA 6 and/or PA 6.6, of a bisoxazoline, preferably 2,2′-(1,3-phenylene)bis(2-oxazoline) or 2,2′-(1,4-phenylene)bis(2-oxazoline), and
according to a quantity inclusively comprised between 0.3 and 3 part by weight per one hundred parts of polyamide(s) PA 6 and/or PA 6.6, of a biscaprolactame, preferably 1,1′-isophthaloyl biscaprolactame.
